(19) United States
(12) Patent Application Publication
(10) Pub. No.: US 2007/0124377 A1
(43) Pub. Date: May 31, 2007

(54) APPARATUS AND METHOD FOR A COMMUNICATION CONFERENCE

(75) Inventors: Andreas Schmidt, Braunschweig (DE); Achim Luft, Braunschweig (DE); Holger Schmidt, Braunschweig (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Munich (DE)

(21) Appl. No.: 11/549,201

(22) Filed: Oct. 13, 2006

(30) Foreign Application Priority Data
Oct. 13, 2005 (DE) 10 2005 049 074.3

(51) Int. Cl. G06F 15/16

(52) U.S. Cl. 709/204

(57) ABSTRACT

A communication conference including at least one unambiguously identifiable conference media data flow. The access right within the communication conference is assigned by taking into consideration the conference media data flow.

### CROSS-REFERENCE TO RELATED APPLICATION

This application claims priority to German Patent Application Serial No. 2005 049 074.3-31, which was filed Oct. 13, 2005, and is incorporated herein by reference in its entirety.

1. Technical Field

The invention relates to a method for the computer-aided assigning of an access right, a method for the computer-aided generating of an access right request message, an access right assignment unit, a communication conference server unit, a communication conference message generating unit, a communication terminal and a method for the computer-aided initializing of a conference message flow in a communication conference.

2. Background of the Invention

A communication conference system provides the possibility for communication between a number of users with the aid of communication terminals.

To provide for orderly communication, usually not all parties to a conference or to a communication session, respectively, simultaneously receive the right for communicating via a particular medium such as, for example, audio, video etc. The right for communication will also be called access right in the text which follows. The access right is usually assigned in accordance with predetermined rules. The assignment of the access right is frequently also called floor control and the rules which are followed as part of the assignment of the access right are frequently also called floor policy.

User-friendly and efficient methods for the assignment of the access right are desirable.

### BRIEF DESCRIPTION OF THE FIGURES

FIG. 1 shows a communication system according to an exemplary embodiment of the invention with four parties;

FIG. 2 shows a message flow diagram according to an exemplary embodiment of the invention;

FIG. 3 shows a message flow diagram according to an exemplary embodiment of the invention;

FIG. 4 shows a message flow diagram according to an exemplary embodiment of the invention;

FIG. 5 shows a message flow diagram according to an exemplary embodiment of the invention;

FIG. 6 shows a message flow diagram according to an exemplary embodiment of the invention; and

FIG. 7 shows a message flow diagram according to an exemplary embodiment of the invention.

### DESCRIPTION OF THE INVENTION

In large conference rooms, a conference system is often used in which a number of microphones and loudspeakers are provided to the parties for voice communication. The microphones must be switched on by the respective speaker in order to be used. A microphone that is switched on blocks all other microphones so that only one speaker can always be active, in other words, has the right to speak. In exceptions, another microphone, for example that of the conference leader, can also be active at the same time. The right to speak is thus usually allocated to only one party and possibly one or more further parties, for example the conference leader.

In the field of mobile radio communication, comparable communication services for providing a conference between a number of communication terminals are known, for example, so-called half duplex conference systems or communication services rendered within such a context are known in this field, for example a so-called Push-to-Talk (PTT) communication service, for example the communication service “Direct Connect” by the Nextel company or the communication service Push-to-Talk over cellular (PoC) by the Open Mobile Alliance (OMA) standardization body. Similar to a walkie talkie, the speaker must usually operate a special key on a mobile radio communication terminal in this case in order to be able to convey messages. The transmission of messages of other users is blocked during this time.

In current Push-to-Talk conference systems, access rights are frequently controlled by the so-called Real-Time Transport Control Protocol (RTCP), that is to say, this protocol is used for requesting and assigning access rights. As an alternative, the access rights can also be controlled by means of the BFCP in some of these conference systems.

The parties to a conference can be notified about the state of the conference by means of so-called notification messages. Thus, for example, the parties can be notified about which party is requesting the right to speak, generally the access right for a particular medium. Notification messages are communicated in an IETF conference system by using the Session Initiation Protocol (SIP) communication protocol. In a present-day Push-to-Talk communication system, the parties are notified about which party is receiving the right to speak by using the Real-Time-Transport-Control-Protocol (RTCP) communication protocol.

Conference systems according to the IETF and Push-to-Talk systems usually have a centralized architecture. This means that the parties in a conference provided by such a conference system do not communicate with one another directly by means of a central server unit. In a mobile conference system, the central server unit is usually located in the non-mobile part of the communication network.

In the known communication conference systems, a disadvantageous factor in the assignment of access rights is, for example, that the chair which assigns the access right does not know, when the access right is requested, which preceding communication contribution the new communication contribution will be related to. For this reason, the chair cannot assign the access right in accordance with the relationships between the communication contributions. The communication and the assignment of the access right is thus frequently unstructured.

According to an exemplary embodiment of the invention, the access right assignment in a communication conference is regulated in a more structured manner than in the case of conventional conference systems.

According to an exemplary embodiment of the invention, a method for the computer-aided assignment of an access right in a communication conference between a number of communication terminals is provided at at least one communication terminal, wherein the communication conference has at least one unambiguously identifiable conference message flow, the access right within the communication conference is assigned taking into consideration the conference message flow.

According to another exemplary embodiment of the invention, a method for the computer-aided generating of a communication conference message in a communication conference between a number of communication terminals is provided in which an identification information of a conference message flow within the communication conference is added to the communication conference message for unambiguously identifying the conference message flow or a communication contribution in the conference message flow.

According to a further exemplary embodiment of the invention, an access right assignment unit for assigning an access right in a communication conference between a number of communication terminals to at least one communication terminal is provided, wherein the communication conference has at least one unambiguously identifiable conference message flow, which unit is set up in such a manner that the access right is assigned within the communication conference taking into consideration the conference message flow.

According to a further exemplary embodiment of the invention, a communication conference server unit with an access right assignment unit as described above is provided.

A communication conference message generating unit, for example an assignment right request message generating unit according to an exemplary embodiment of the invention is set up for the computer-aided generating of a communication conference message, for example for generating an assignment right request message, in a communication conference between a number of communication terminals, wherein an identification information of a conference message flow within the communication conference can be added to the communication conference message, for example the assignment right request message, for the unambiguous identification of the conference message flow.

According to an exemplary embodiment of the invention, a communication terminal is provided with a communication conference message generating unit, described above, for example an assignment right request message generating unit.

In a method for the computer-aided initializing of a conference message flow in a communication conference between a number of communication terminals according to an exemplary embodiment of the invention, a conference message flow is generated in the communication conference, wherein an unambiguous identification information is allocated to the conference message flow for the unambiguous identification of the message flow within the communication conference.

In an embodiment of the invention, assignment rights related to a preceding communication contribution are requested and assigned in a communication system, also called conference system, with a number of parties.

In this context, it is assumed without restriction of the general validity, that each communication contribution initiates a thread, also called conference message flow in the text which follows. All subsequent contributions which relate to the original communication contribution belong to a thread of a communication contribution. To each thread of a communication session, a separate access right control and an access right control unit provided and set up for this purpose is allocated. The access right control of a thread is chaired, for example, by the party who has initiated the thread by means of his communication contribution. When a party requests the access right, he can provide information about which preceding communication contribution his contribution is related to. His contribution is then allocated to the thread which was initiated by the reference contribution.

An advantage of embodiments of the invention can be seen in that the sequence of a communication session is regulated in accordance with the dependences of the communication contributions and thus the communication message flows. Contributions belonging together with regard to a communication contribution which initiates a respective thread are processed first, for example, before other contributions can be made. In this manner, an automatically structured communication session is rendered possible. Furthermore, an advantage can be seen in the fact that in the request for the access right, the preceding communication contribution is specified to which the new contribution is related. The reference can be conveyed to the other parties or their communication terminals, respectively, so that they can correlate the contribution with respect to subject matter even before listening to the contribution, manually or also automatically.

Furthermore, when corresponding communication protocols are used, embodiments of the invention can be implemented by extending existing access right control mechanisms so that it cooperates with the existing mechanisms, that is to say is “backward compatible”.

Embodiments of the invention are obtained from the dependent claims.

As far as appropriate, the embodiments of the invention relate to all methods described above and also the access right allocation unit, the communication conference server unit, the access right request message generating unit and the communication terminal.

The at least one conference message flow can have at least one contribution which relates to the communication conference or also to another contribution in the communication conference.

The communication conference can have a number of unambiguously unidentifiable conference message flows which, for example, are in each case attributable to a separate communication contribution and are allocated to this. The access right can be assigned within the communication conference by taking into consideration at least one conference message flow of the number of conference message flows. Embodiments of the invention are particularly advantageous if a multiplicity of communication contributions initiated by a respective conference message flow are provided and, in the context of the communication conference, a more structured and more ordered processing of the access right requests and, associated with this, of the entire communication conference, is desired since, according to the present embodiment of the invention, it is made possible, by using the respective identification information, to unambiguously identify each message flow or, respectively, the communication contribution initiating it, even among a multiplicity of different conference message flows and unambiguously referencing each subsequent contribution thereto.

The access right can be assigned by taking into consideration an access right request message as described above, wherein the access right request message contains the identification information of the respective conference message flow to which the access right request message is related.

According to an embodiment, at least one access right request message is received, wherein, following the reception of the access right request message, the respective access right is also assigned.

According to another embodiment of the invention, it is provided that the at least one access right request message contains an identification information for identifying the conference message flow within the context of which an access right is requested.

Furthermore, a communication session-based communication conference can be used as communication conference, for example an Internet-based communication conference or a Push-to-Talk communication conference, and, for example, a Push-to-Talk of a cellular communication conference can then be used.

According to another embodiment of the invention, it is provided to code the communication conference message, for example the access right request message, in accordance with an access right assignment protocol, for example, according to the Binary Floor Control Protocol (BFCP).

Furthermore, the communication conference message, for example the access right request message, can be coded in accordance with a control protocol for controlling a media data transmission protocol, for example according to a real-time control protocol for controlling a real-time media data transmission protocol, for example according to the Real-Time Transport Control Protocol (RTCP).

When these protocols are used, which are known per se, an advantage can be seen in the fact that the mechanism described above can be implemented by means of a very simple and cost-effective extension of these protocols known per se, as a result of which such an implementation is “backward compatible” to the current communication mechanisms and communication conference systems.

The access right within the communication conference can be assigned by the initiator of the conference message flow, or in other words, by the party to the communication conference which has supplied the communication contribution which has initiated the respective conference message flow.

The initiator is, for example, the party which has made the contribution to which the contributions of the conference message flow are related.

As an alternative or in addition, the access right can be assigned within the communication conference by an initiator of a conference message flow, a thread in other words, which is of hierarchically higher level than the conference message flow.

According to another embodiment of the invention, it is provided that the initiator of the conference message flow or the initiator of the conference message flow of higher level than the conference message flow has the right also to terminate the respective conference message flow. In this case, it is provided, for example, that, when a thread is terminated, all associated communication requests not yet authorized are rejected and, if necessary, a contribution currently taking place is terminated. This ensures that the contributions and the message flows are in each case not chaired by parties to the communication conference who are strangers to the subject and are thus controlled with regard to the access right assignment.

The communication conference message can be one of the following messages or arranged as one of the following messages, for example:
an access right request message for requesting an access right;
a message flow access right authorization message, wherein the message flow access right authorization message specifies that the access right was authorized in the message flow;
a message flow terminating message for terminating the conference message flow;
a message flow access right withdrawal message for withdrawing the access right in the message flow;
a communication contribution terminating message for terminating the communication contribution;
a communication contribution release message, wherein the communication contribution release message specifies that the access right with regard to the communication contribution is not assigned;
a communication contribution terminating message for releasing the communication contribution;
an access right assignment message wherein the access right assignment message specifies that the access right has been assigned;
a communication contribution access right withdrawal message for withdrawing the access right in the communication contribution.

The message flow terminating message and/or the message flow access right withdrawal message, for example, can be generated by the chair of the conference message flow.

Exemplary embodiments of the invention are shown in the figures and will be explained in greater detail in the text which follows.

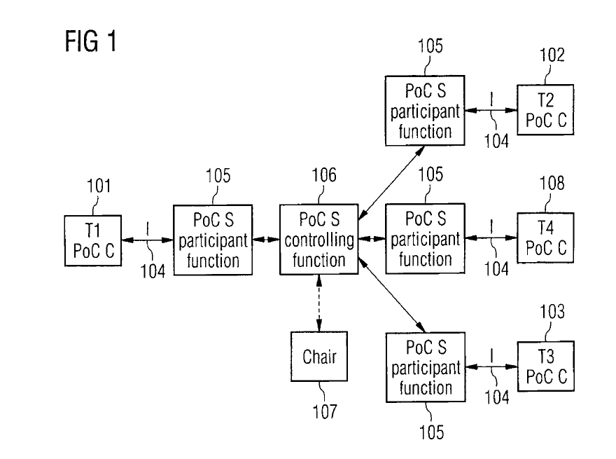

To provide a simpler representation of the invention, an embodiment of the invention is first shown with reference to FIG. 1, in which the communication system and the units provided therein are set up as Push-to-Talk over Cellular communication system (PoC communication system) 100, wherein a chair is provided for chairing one or more PoC communication session(s).

A first PoC client unit 101, a second PoC client unit 102, a third PoC client unit 103 and a fourth PoC client unit 108 are coupled by means of in each case one interface I 104 to in each case one PoC server participating function 105. The PoC server participating functions 105 are coupled to a PoC server controlling function 106.

The PoC server controlling function 106 is coupled to a chair 107. The chair 107 can be implemented by means of a PoC client unit 101, 102, 103, 108 or by mean of a server computer of the communication system 100. The chair 107 is illustratively the chair of a respective PoC communication session. For example, the PoC server controlling function 106 can inquire from the chair 107 which PoC client unit 101, 102, 103, 108 the right to speak, generally the access right, is to be assigned to or at what point the PoC server controlling function 106 is to place a PoC client unit 101, 102, 103, 108 into a queue. The chair 107 himself can also conduct a queue and the PoC server controlling function 106 can request information about the state of the queue from the chair 107. The interfaces I 104 are provided, for example, by means of the RAN (Radio Access Network), the Core Network (CN) and the IMS (Internet Protocol based Multimedia Subsystem) of a UMTS (Universal Mobile Telecommunications System) communication system or a GSM (Global System for Mobile Communication) communication system.

However, the interfaces I 104 can also be provided, for example, by means of a PSTN (Public Switched Telephone Network) communication network.

The PoC client units 101, 102, 103, 108 are in each case integrated in a mobile radio communication terminal which is set up according to the respective interface I 104, for example for communication according to the UMTS standard, the GSM standard, the GPRS (General Packet Radio Service) standard, the CDMA 2000 standard, the FOMA standard or another mobile radio communication standard.

In the text which follows, an embodiment is explained in which the chair 107 makes a decision about which PoC client unit 101, 102, 103, 108 receives the right to speak.

Illustratively, the PoC server controlling function 106 forwards the talk burst control signaling received by it to the chair 107 which, in turn, informs the PoC server controlling function 106 about its decision which PoC client unit 101, 102, 103 receives the right to speak and in what order the PoC client units 101, 102, 103, 108 receive the right to speak. The PoC server controlling function 106 thereupon sends corresponding signaling to the PoC client units 101, 102, 103, 108 involved.

Initially, an embodiment will be explained in which no queue is being conducted.

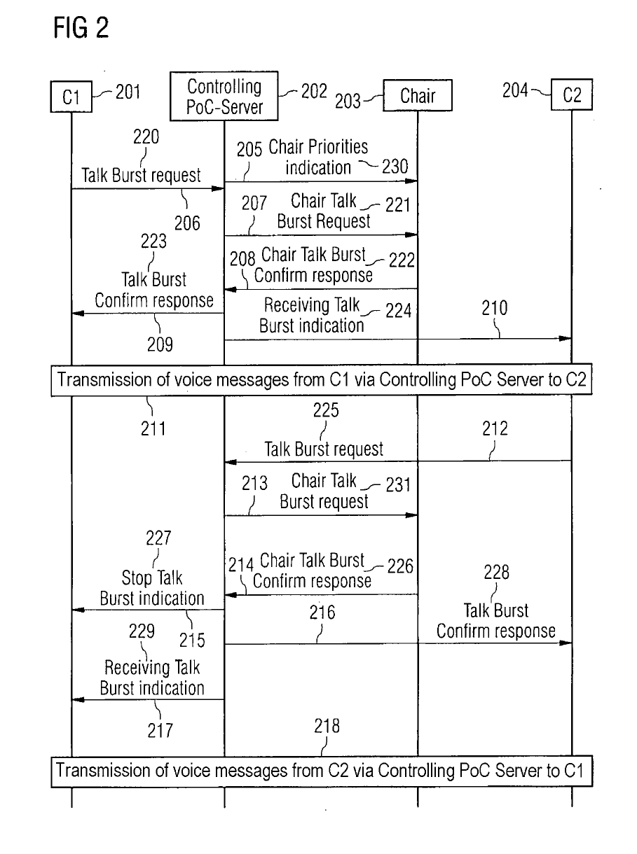

FIG. 2 shows a message flow diagram 200 according to an exemplary embodiment of the invention.

The message flow shown in FIG. 2 takes place between a first PoC client unit 101, 201, a PoC server controlling function 106, 202, a chair 107, 203 and a second PoC client unit 102, 204 which are arranged and embodied as explained above with reference to FIG. 1.

In step 206, the first PoC client unit 101, 201 sends a Talk_Burst_Request message 220 to the PoC server controlling function 106, 202 with which it requests the right to speak. In step 207, the PoC server controlling function 106, 202 forwards this request to the chair 107, 203 by means of a Chair_Talk_Burst_Request message 221 which is arranged, for example, according to Table 1.

TABLE 1
Chair_Talk_Burst_request

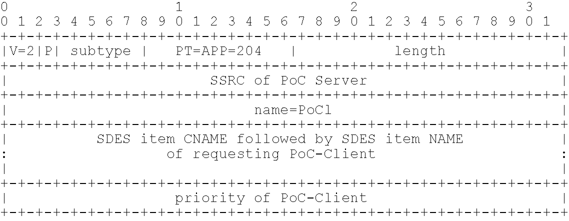

Since the sender of the Chair_Talk_Burst_Request message 221 is in this case the PoC server controlling function 106, 202, the Chair_Talk_Burst_Request message 221 in this case contains the SSRC of the PoC server controlling function 202 as sender identification. The Chair_Talk_Burst_Request message 221, therefore, additionally contains a field with the identification of the first PoC client unit 101, 201.

The Chair_Talk_Burst_Request message 221 also contains the priority of the first PoC client unit 101, 201. However, this is optional. For example, the Chair_Talk_Burst_Request message 221 could contain the priority of the first PoC client unit 101, 201 only when it requests the right to speak for the first time during the PoC communication session. As an alternative, the priority of the first PoC client unit 101, 201 can be contained in the Chair-Talk-Burst-Request message 221 only when the priority has changed with respect to the last transmission of the priority to the chair 203.

A further alternative, which is used, for example, when the priorities of the PoC client units 101, 102, 103, 108 do not change during a PoC communication, is to transmit at the beginning of the PoC communication session, in step 205, a Chair_Priorities_Indication message 230 which is arranged, for example, according to Table 2 (from the PoC server controlling function 106, 202) to the chair 107, 203.

TABLE 2
Chair_Priorities_Indication

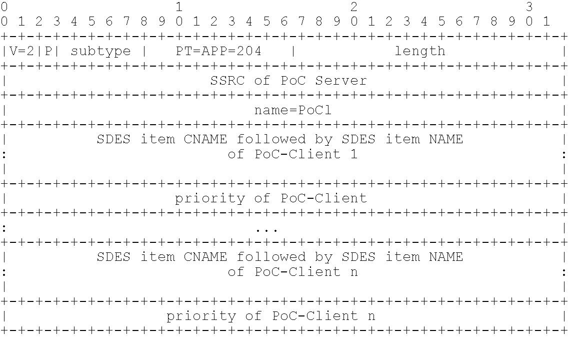

As shown in Table 2, the Chair_Priorities_Indication message 230 contains for each PoC client unit 201, 204 a field with an identification of the PoC client unit 201, 204 and the priority of the respective PoC client unit 201, 204.

In one embodiment, a Chair_Priorities_Indication message 230 is retransmitted when the priority of a PoC client unit 201, 204 has changed.

In the case, not shown in FIG. 2, where a PoC client unit 201, 204 has the right to speak and signals the handover of the right to speak to the PoC server controlling function 202 by means of the transmission of a Talk Burst Completed Indication message, the server controlling function 202 sends a Chair_Talk_Burst_Completed_Indication message, which, for example, is arranged according to Table 3, to the chair 107, 203.

TABLE 3
Chair_Talk_Burst_Completed_Indication

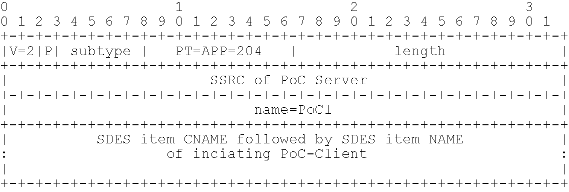

In step 208, the chair 107, 203 informs the PoC server controlling function 106, 202 about the result of its decision whether the first PoC client unit 101, 201 receives the right to speak. This decision can be made by taking into consideration the priority of the first PoC client unit 101, 201.

In the present example, it is assumed that the chair 107, 203 decides that the first PoC client unit 201 receives the right to speak. Accordingly, the chair 107, 203 transmits a Chair_Talk_Burst_Confirm_Response message 222 in step 208 to the PoC server controlling function 106, 202. In the present example, the Chair_Talk_Burst_Confirm_Response message 222 is arranged according to Table 4 and contains an identification of the PoC client unit 201, 204 to which the right to speak is to be granted, in the present example the first PoC client unit 101, 201.

TABLE 4
Chair_Talk_Burst_Confirm_Response

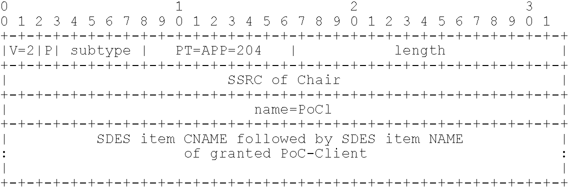

In the case where the chair 107, 203 decides that the right to speak is not granted to the first PoC client unit 101, 201, the chair 107, 203 transmits, in step 208, a Chair_Talk_Burst_Reject_Response message to the PoC server controlling function 202, which is arranged, for example, according to Table 5 and contains an identification of the PoC client unit 201, 204 which is denied the right to speak, a specification of a reason for the denial (Reason Code), the length of a specification of a reason (Length) and the specification of a reason (Reason Phrase).

TABLE 5
Chair_Talk_Burst_Reject_Response

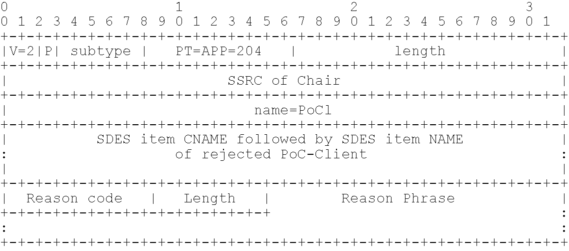

Since it is assumed in the present example that the right to speak is granted to the first PoC client unit 101, 201, the PoC server controlling function 106, 202 correspondingly sends a Talk_Burst_Confirm_Response message 223 to the first PoC client unit 101, 201 in step 209.

Furthermore, the PoC server controlling function 106, 202 transmits a Receiving_Talk_Burst_Indication message 224 to the second PoC client unit 101, 204 in step 210.

Furthermore, the first PoC client unit 101, 201 begins to transmit voice messages to the second PoC client unit 102, 204 in step 211.

It is then assumed that, in step 212, the second PoC client unit 102, 204 requests the right to speak as part of the PoC communication by means of a further Talk Burst Request message 225.

Analogously to step 207, the PoC server controlling function 106, 202 transmits a further Chair_Talk_Burst_Request message 231 to the chair 107, 203 (step 213).

It is assumed in the present example that the priority of the second PoC client unit 102, 204 is higher than that of the first PoC client unit 101, 201. Correspondingly, the chair 107, 203 decides that the right to speak should now be granted to the second PoC client unit 102, 204 and informs the PoC server controlling function 106, 202 of this by means of a further Chair_Talk_Burst_Confirm_Response message 226 (step 214).

In step 215, the PoC server controlling function 106, 202 informs the first PoC client unit 101, 201 by means of a Stop_Talk_Burst_Indication message 227 (see Table 6) that the first PoC client unit 101, 201 has to relinquish the right to speak and accordingly has to terminate the transmission of voice messages.

Table 6 contains a list of messages for the Talk Burst Control during a PoC communication session.

TABLE 6

| Direction of | | |
|---|---|---|
| transmission | Message | |
| of the message | designation | Description of the message |
| Client -> | Talk Burst | a PoC client unit asks the |
| Serverrechner | request | PoC server controlling |
| | | function whether it can |
| | | receive the right to speak |
| Serverrechner -> | Talk Burst | the PoC server controlling |
| Client | Confirm response | function confirms that the |
| | | requesting PoC client unit |
| | | has the right to speak |
| Serverrechner -> | Talk Burst Reject | the PoC server controlling |
| Client | response | function denies the right |
| | | to speak to the requesting |
| | | PoC client unit |
| Serverrechner -> | Receiving Talk | the PoC server controlling |
| Clients | Burst indication | function informs all PoC |
| | | client units (except the |
| | | PoC client unit having the |
| | | right to speak) that the |
| | | right to speak has been |
| | | assigned and thus voice |
| | | messages are now also sent |
| Client -> | Talk Burst | a PoC client unit with the |
| Serverrechner | Completed | right to speak informs the |
| | indication | PoC server controlling |
| | | function that it |
| | | relinquishes the right to |
| | | speak |
| Serverrechner -> | No Talk Burst | the PoC server controlling |
| Clients | indication | function informs all PoC |
| | | client units that |
| | | currently nobody has the |
| | | right to speak and thus no |
| | | voice messages are sent |
| | | out either |
| Serverrechner -> | Stop Talk Burst | the PoC server controlling |
| Client | indication | function withdraws the |
| | | right to speak from a PoC |
| | | client unit with the right |
| | | to speak |

The messages contained in Table 6 are implemented as RTCP APP packets, that is to say by means of the packet type for application-specific functions (APP) of the Real-Time Control Protocol (RTCP).

In the case where the chair 107, 203 itself withdraws the right to speak from a PoC client unit 201, 204 which has the right to speak, it signals this to the PoC client unit 201, 204 by means of a Chair_Stop_Talk_Burst_Indication message which is arranged, for example, according to Table 7.

TABLE 7
Chair_Stop_Talk_Burst_Indication

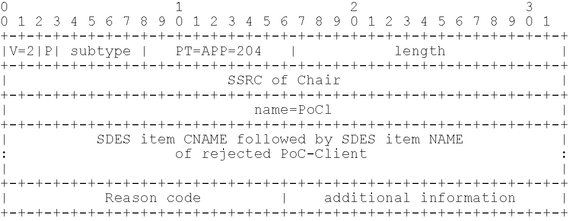

The Chair_Stop_Talk_Burst_Indication message shown in Table 7 contains the identification of the PoC client unit which currently has the right to speak and from which the right to speak is withdrawn, and the specification of a reason why the PoC client unit must terminate the transmission of voice messages (Reason Code) and a field for additional information.

Analogously to step 209, the PoC server controlling function 106, 202 transmits a further Talk_Burst_Confirm_Response message 228 to the second PoC client unit 102, 204 in step 216.

Analogously to step 210, the PoC server controlling function 106, 202 transmits a further Receiving_Talk_Burst_Indication message 229 to the first PoC client unit 101, 201 in step 217.

Analogously to step 211, the second PoC client unit 102, 204 begins to transmit voice messages to the first PoC client unit 101, 201 (step 218).

In the further text, an embodiment is explained in which the decision about which PoC client unit 101, 102, 103, 108 receives the right to speak is made by the chair 107, wherein a queue is administered by the PoC server controlling function 106.

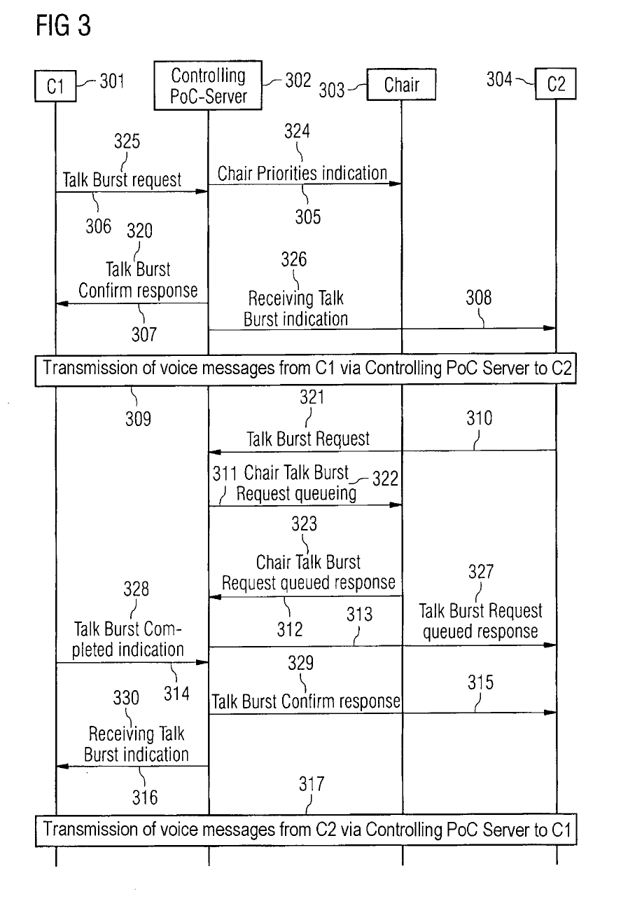

FIG. 3 shows a message flow diagram 300 according to an exemplary embodiment of the invention.

The message flow shown takes place between a first PoC client unit 101, 301, a PoC server controlling function 106, 302, a chair 107, 303 and a second PoC client unit 102, 304 which are arranged and embodied as described with reference to FIG. 1.

Steps 305 (sending a Chair_Priorities_Indication message 324 from the PoC server controlling function 106, 302 to the chair 107, 303) and 306 (sending a Talk_Burst_Request message 325 from the first PoC client unit 101, 301 to the PoC server controlling function 106, 302) are performed analogously to steps 205 and 206 in FIG. 2.

Since it is assumed in the present example that the queue, which is administered by the PoC server controlling function 106, 302, is empty, the PoC server controlling function 106, 302 does not ask the chair 107, 303 but grants the right to speak to the first PoC client unit 101, 301 in step 307, analogously to step 209 in FIG. 2, by means of a Talk_Burst_Confirm_Response message 320.

Steps 308 (sending a Receiving_Talk_Burst_Indication message 326 from the PoC server controlling function 106, 302 to the second PoC client unit 102, 304) and 309 (transmitting voice data from the first PoC client unit 101, 301 by means of the PoC server controlling function 106, 302 to the second PoC client unit 102, 304) are performed in accordance with steps 210 and 211 in FIG. 2.

It is assumed that, in step 310, the second PoC client unit 102, 304, analogously to step 212, sends the request for the right to speak to the PoC server controlling function 106, 302 by means of a Talk_Burst_Request message 321.

Since in the present case, the right to speak is currently granted to the first PoC client unit 101, 301, the PoC server controlling function 106, 302, in step 311, asks the chair 107, 303 by means of a Chair_Talk_Burst_Request_Queueing message 322, which is arranged, for example, according to Table 8, at what position the second PoC client unit 102, 304 is to be entered in the queue administered by the PoC server controlling function 106, 302.

TABLE 8
Chair_Talk_Burst_Request_Queueing

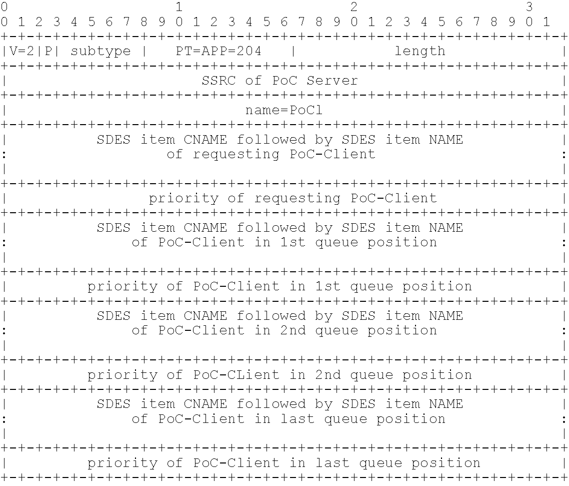

As shown, the Chair_Talk_Burst_Request_Queueing message 322 contains for each PoC client unit 301, 304 carried in the queue an identification of the PoC client unit 301, 304 and the priority of the respective PoC client unit 301, 304 in the order which is specified by the queue, and an identification and the priority of the second PoC client unit 102, 304.

In one embodiment, the second PoC client unit 102, 304 can withdraw the right to speak from the first PoC client unit 101, 301 (instead of being queued only in the first position of the queue, for example) when the first PoC client unit 101, 301 has the right to speak and has a lower priority than the second PoC client unit 102, 304. In this embodiment, the Chair_Talk_Burst_Request_Queueing message 322 can be arranged, for example, according to Table 8a and contains the identification of the first PoC client unit 301, 304 which currently has the right to speak, and the priority of this PoC client unit 301, 304. The chair 107, 304 can correspondingly allow, by means of a Chair_Talk_Burst_Confirm_Response message that the right to speak is withdrawn from the first PoC client unit 101, 301 and assigned to the second PoC client unit 102, 304, or refuse this by means of a Chair_Talk_Burst_Reject_Response message.

In another embodiment, the PoC client unit which currently has the right to speak is always carried at the first position of the queue. Correspondingly, a further PoC client unit having a higher priority than the PoC client unit which currently has the right to speak could withdraw the right to speak by being queued at the first position in the queue and correspondingly the PoC client unit which currently has the right to speak dropping back to the second position in the queue.

TABLE 8a
Chair_Talk_Burst_Request_Queueing (Alternative)

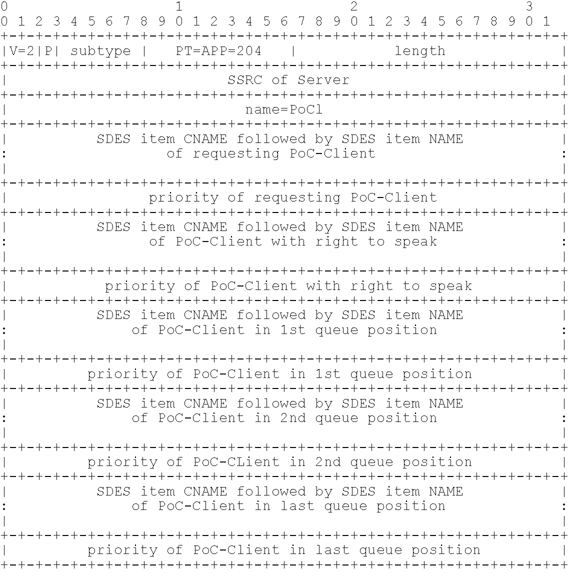

Analogously to the above, the transmission of the priorities by means of the Chair_Talk_Burst_Request_Queueing message 322 can be omitted if the priorities of the PoC client units 301, 304 have been transmitted by means of a Chair_Priorities_Indication message 324 in step 305.

In step 312, the chair 107, 303 transmits the position of the second PoC client unit 102, 304 to the PoC server controlling function 106, 302 by means of a Chair_Talk_Burst_Request_Queued_Response message 323 which is arranged according to Table 9.

TABLE 9
Chair_Talk_Burst_Request_Queued_Response

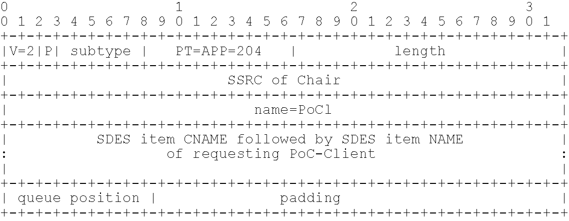

As an alternative, the chair 107, 303 can also transmit the specification of the complete updated queue, that is to say the queue in which the second PoC client unit 102, 304 has been accepted, to the PoC server controlling function 106, 302 in step 312.

This is done by means of a Chair_Talk_Burst_Request_Queue_Result message which is arranged, for example, according to Table 10 and, analogously to the Chair_Talk_Burst_Request_Queueing message 322, contains the information of the queue (now updated).

TABLE 10
Chair_Talk_Burst_Request_Queue_Result

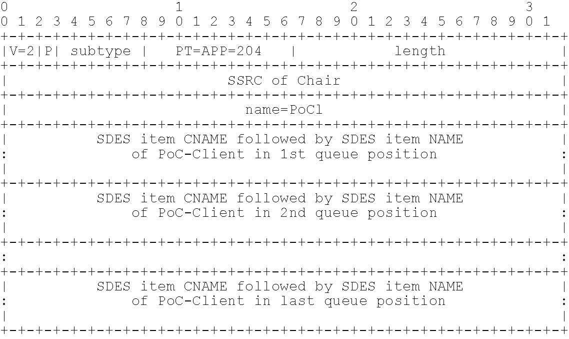

The position of the second PoC client unit 102, 304 in the queue is determined by the chair 107, 303, taking into consideration the priority of the second PoC client unit 102, 304.

The PoC server controlling function 106, 302, therefore, generates an entry for the second PoC client unit 102, 304 in the queue conducted by it and informs the second PoC client unit 102, 304 in step 313 by means of a further Talk_Burst_Request_Queued_Response message 327 that it is entered in the queue.

In step 314, the first PoC client unit 101, 301 informs the PoC server controlling function 106, 302 by means of a Talk_Burst_Completed_Indication message 328 that it terminates the transmission of voice data and hands over the right to speak.

Since there is an entry for the second PoC client unit 102, 304 in the queue conducted by the PoC server controlling function 106, 302 and it is assumed in the present example that there is no entry preceding the entry for the second PoC client unit 102, 304 in the queue, the PoC server controlling function 106, 302 now grants the right to speak to the second PoC client unit 102, 304. Accordingly, the PoC server controlling function 106, 302 transmits a further Talk_Burst_Confirm_Response message 329 (step 315) to the second PoC client unit 102, 304.

The further Talk_Burst_Request message 321 and the further Talk_Burst_Confirm_Response message 329 and the Talk_Burst_Completed_Indication message 328 are set up and built up.

Steps 316 (sending a Receiving_Talk_Burst_Indication message 330 from the PoC server controlling function 106, 302 to the first PoC client unit 101, 301) and 317 (transmitting voice data from the second PoC client unit 102, 304 to the first PoC client unit 101, 301 by means of the PoC server controlling function 106, 302) are performed analogously to steps 308 and 309.

In another embodiment, the chair 107 administers a queue. In this case, the chair 107 is contacted by the PoC server controlling function 106 with each request of the PoC client units 101, 102, 103, 108.

In this case, a transmission of a Chair_Talk_Burst_Reject_Response message or of a Chair_Talk_Burst_Request_Queued_Response message as were described above is also possible in addition to the transmission of a Chair_Talk_Burst_Confirm_Response message 222 in step 208 of the message flow diagram 200 shown in FIG. 2. If one of the PoC client units 101, 120, 103, 108 asks the PoC server controlling function 106 for the position of the entry corresponding to the PoC client unit 101, 102, 103, 108 in the waiting list, for example by means of a Talk_Burst_Queue_Position_Request message described above, the PoC server controlling function 106 contacts the chair 107 by means of a Chair_Talk_Burst_Queue_Position_Request message which is arranged, for example, according to Table 11.

TABLE 11
Chair_Talk_Burst_Queue_Position_Request

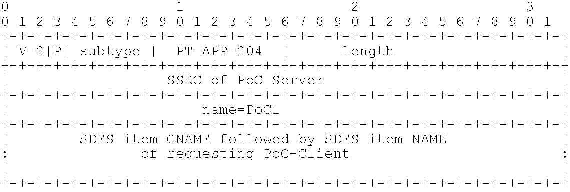

The Chair_Talk_Burst_Queue_Position_Request message contains a specification of the PoC client unit 101, 102, 103, 108 which has made the enquiry.

The chair 107 then responds to the PoC server controlling function 106 by means of a Chair_Talk_Burst_Queue_Position_Response message which is arranged according to Table 12 and analogously to the Talk_Burst_Queue_Position_Response message described above.

TABLE 12
Chair_Talk_Burst_Queue_Position_Response

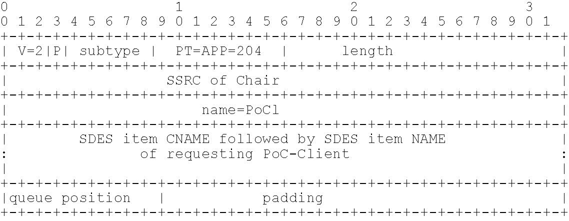

Analogously to the case described above, the Chair_Talk_Burst_Queue_Position_Response message is identical with the Talk_Burst_Request_Queue_Response message 323 apart from the “subtype” field and the specification of the sender address.

If a PoC client unit 101, 102, 103, 108 asks about the total state of the queue, for example by means of a Talk_Burst_Queue_Identity_Request message, the PoC server controlling function 106 contacts the chair 107 by means of a Chair_Talk_Burst_Queue_Identity_Request message which is arranged according to Table 13 and by means of which the enquiry is forwarded to the chair 107.

TABLE 13
Chair_Talk_Burst_Queue_Identity_Request

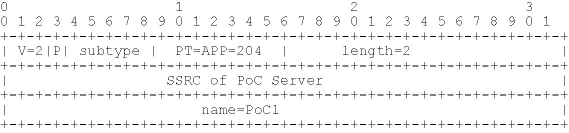

The chair 107 responds to this enquiry by means of a Chair_Talk_Burst_Queue_Identity_Response message which is arranged, for example, according to Table 14 and is identical with the Talk_Burst_Queue_Identity_Response message apart from the “subtype” field and the field that contains the specification of the sender of the message.

TABLE 14
Chair_Talk_Burst_Queue_Identity_Response

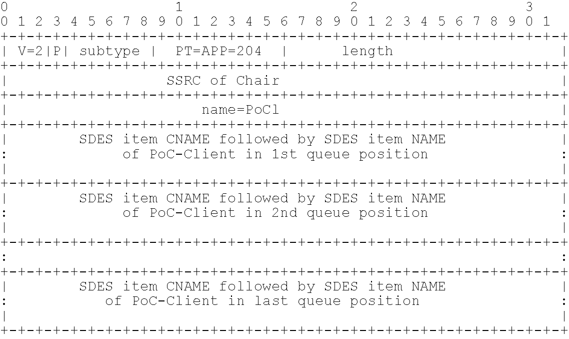

If a PoC client unit 101, 102, 103, 108 reports, for example by means of a Talk_Burst_Request_Cancellation message, as explained above, that it no longer requests the right to speak, that is to say an entry corresponding to the PoC client unit 101, 102, 103, 108 is to be removed from the queue, the PoC server controlling function 106 forwards this information to the chair 107 by means of a Chair_Talk_Burst_Request_Cancellation message which is arranged, for example, according to Table 15 and is arranged analogously to the Talk_Burst_Request_Cancellation message.

TABLE 15
Chair_Talk_Burst_Request_Cancellation

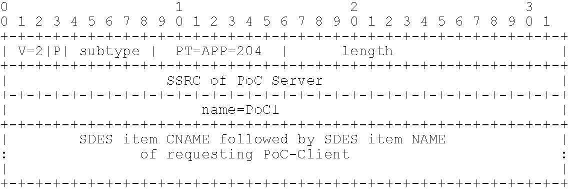

In the text which follows, an embodiment of the invention will be described in which the chair mechanism described above (with or without queue) is used for granting an access right during a communication conference.

The embodiments described in the text which follows are also based on the communication system shown in FIG. 1 and described above in detail, the chair 107 in each case being implemented in a PoC client unit, namely in the first PoC client unit 101 which is implemented in a first mobile radio communication terminal, in the text which follows, without restriction of the general validity. The push-to-talk communication system 100 and the components provided therein are set up according to the OMA standard, the individual components also being set up for performing the method steps described in the text which follows and for coding and decoding the corresponding messages.

Thus, according to the embodiments following, the parties, in the present case four parties with in each case one mobile radio communication terminal, do not communicate directly with one another but by means of the central PoC server controlling function 106. The parties and their mobile radio communication terminals, respectively, communicate with one another by audio.

The access right control and, for example, the access right assignment, too, is carried out by using RTCP messages according to the OMA communication standard, using the extension by the chair 107, described above, and the associated extensions of the RTCP messages as were described above.

According to the embodiments following, it is assumed that the first party T1, that is to say the user of the first mobile radio communication terminal, and thus the first PoC client unit 101 creates a Push-To-Talk communication session (PTT) communication session).

This occurs by the first party T1 inviting the other parties T2, T3, T4 to the PTT communication session, for example by means of corresponding SIP (Session Initiation Protocol) INVITE messages which are generated by the first PoC client unit 101 and are sent to the respective PoC client units of the parties T2, T3, T4 to be invited.

The mobile radio communication terminals of the parties T2, T3, T4 or, respectively, their PoC client units 102, 103, 108 receive the respective SIP INVITE message and accept the invitation by means of corresponding SIP confirmation messages which is in each case generated by the respective PoC client unit 102, 103, 108 and is sent to the first PoC client unit 101. The PTT communication session is thus created and the PoC client units 101, 102, 103, 108 can now exchange data with one another according to the communication protocols used in each case, for example audio data, alternatively or additionally video data, still image data, text data, etc.

Since the first party T1 or, respectively its first PoC client unit 101 has created the PTT communication session, it becomes chair of the PTT communication session and thus has the right for assigning the access right during this PTT communication session.

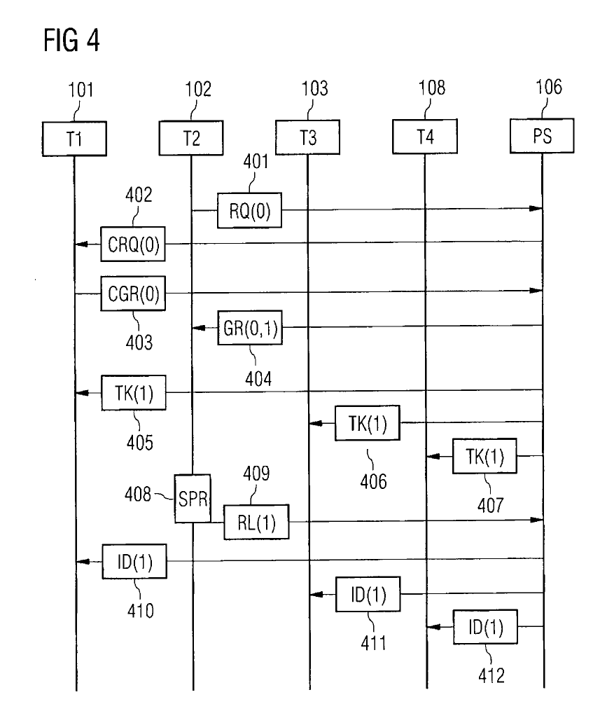

The message flow diagram 400 in FIG. 4 shows the data flow for requesting, assigning and for carrying out a communication contribution, the PTT communication session already being created completely, for example in the manner described above, according to FIG. 4.

According to the present exemplary embodiment of the invention, it is assumed that the second party T2, and thus the second mobile radio communication terminal and thus the second PoC client unit 102 is the first one to request the right to speak from the PoC server controlling function 106 by means of a first TB_Request message 401 (TB is the abbreviation for Talk Burst selected for this description).

The first TB_Request message 401 is an RTCP message and contains, as will still be explained in greater detail in the text which follows, a reference, also called identification information (ID) in the text which follows, a first identification information having the value “0” according to the present exemplary embodiment, to the thread, also called conference message flow in the text which follows, of the communication session. The reference means that a talk burst (right to speak) is requested for the conference message flow of the communication session. The first TB_Request message 401 is thus generated by the second PoC client unit 102 and transmitted to the PoC server controlling function 106. The PoC server controlling function 106 forwards the request to the chair (in the present example the first PoC client unit 101) in that the PoC server controlling function 106 generates a first Chair_TB_Request_message 402 and transmits it to the first PoC client unit 101. The first Chair_TB_Request_message 402 also contains the first identification information having the value “0” which is contained in the first TB_Request message 401.

The Table 16 following shows by way of example the format of the first TB_Request message 401 and of the first Chair_TB_Request_message 402:

TABLE 16
TB_Request/Chair_TB_Request

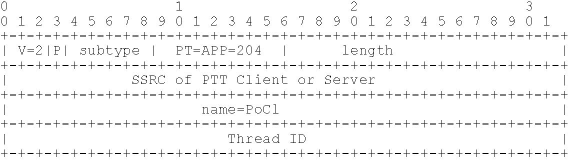

In detail, the fields of the RTCP message shown in Table 16 have the following meaning:
V=2
   RTP version number;
P:
   Indicator for padding;
Subtype:
   Subtype of the message which identifies the message as “TB_Request” or “Chair_TB_Request” message, respectively;
PT=APP=204:
Indicator for application-defined RTCP message;
Length:
   Length of the message after the length field in words (32 bits);
SSRC:
   Synchronization source of the initiating PoC party; the SSRC identifies the sender of media streams unambiguously; it is defined in the RTP packets belonging to the RTCP message;
Name=PoC1:
   Application-defined message name (PoC1=PTT over cellular version 1);
Thread ID:
   Identifier of the thread for which the access right is requested; by default, the thread of the PTT communication session has the value “0” according to the present exemplary embodiment.

In the present case, the reference has an identification information (thread ID) for the conference message flow of the PTT communication session. By default, the identification information of the conference message flow of the PTT communication session has the value “0” according to the present exemplary embodiment.

The chair, i.e. the first party T1 in this case, authorizes the request by means of a first Chair_TB_Granted_message 403 generated by the first PoC client unit 101 and transmitted to the PoC server controlling function 106.

Following the reception of the first Chair_TB_Granted message 403, the PoC server controlling function 106 generates a first TB_Granted_message 404 and transmits it to the second PoC client unit 102, and thus to the second party T2. The PoC server controlling function 106 inserts into the first TB_Granted_message 404 a thread identification information not yet used (a second identification information with the value “1” according to the present exemplary embodiment). The thread identification information serves to provide for a later reference to the thread of the authorized talk burst. In addition, the PoC server controlling function 106 notifies all other parties apart from the second party T2, by means of a respective TB_Taken_message 405, 406, 407 that the talk burst 408 has been assigned.

In detail, the PoC server controlling function 106 generates
a first TB_Taken_message 405 and transmits it to the first PoC client unit 101, and thus to the first party T1,
a second TB_Taken_message 406 and transmits it to the third PoC client unit 103, and thus to the third party T3,
a third TB_Taken_message 407 and transmits it to the fourth PoC client unit 108, and thus to the fourth party T4.

The TB_Taken_messages 405, 406, 407 also in each case contain the thread identification information for the authorized talk contribution (generally the authorized communication contribution), in the present case in each case the second identification information with the value “1”.

The next Table 17 shows by way of example the format of a Chair_TB_Granted_message as RTCP message for authorizing the access right by a chair with specification of the thread for which the access right is granted.

TABLE 17
Chair_TB_Granted

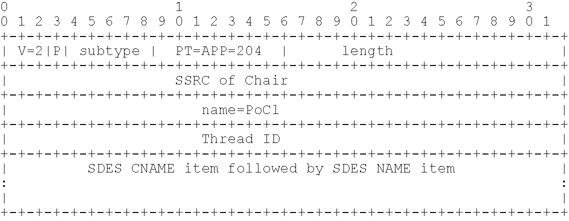

In detail, the fields of the RTCP message shown in Table 17 have the following meaning:
V=2:
   RTP version number;
P:
   Indicator for padding;
Subtype:
   Subtype of the message which identifies the message as “Chair_TB_Granted” message;
PT=APP=204:
   Indicator for application-defined RTCP message;
Length:
   Length of the message after the length field in words (32 bits);
SSRC:
   Synchronization source of the chair who grants the access right. The SSRC identifies unambiguously the sender of media streams; it is defined in the RTP packets belonging to the RTCP message;
Name=PoC1:
   Application-defined message name (PoC1=PTT over cellular version 1);
Thread ID:
   Identifier of the thread for which the access right is granted;
SDES CNAME item followed by SDES NAME item:
   CNAME and NAME of the user terminal to which the access right is to be granted;
   CNAME and NAME are so-called SDES items which are defined in SDES RTCP packets in order to describe an RTP party;
   CNAME is an unambiguous name of the party which continues to exist even outside specific RTP sessions (for example composed of user name and host IP address);
   NAME is any name of the party which is typically specified by the party himself;
   NAME does not need to identify the party unambiguously;
   As in SDES RTCP packets, the list of the SDES items CNAME and NAME is unambiguously concluded by an SDES item of type 00000000; the list is then padded with zeros up to multiples of 32 bits.

The Table 18 following shows by way of example the format of a TB_Granted_message as RTCP message for authorizing the access right by the PoC server controlling function 106 with specification of the thread for which the access right is assigned and with specification of the ID for the new thread which is generated by the authorized communication contribution:

TABLE 18
TB_Granted

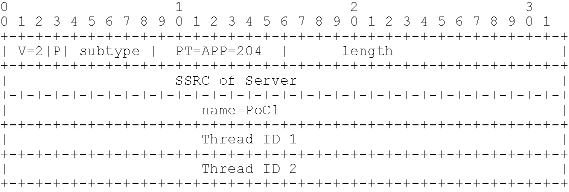

In detail, the fields of the RTCP message shown in Table 18 have the following meaning:
V=2:
   RTP version number;
P:
   Indicator for padding;
subtype:
   Subtype of the message which identifies the message as “TB_Granted” message;
PT=APP=204:
   Indicator for application-defined RTCP message;
Length:
   Length of the message after the length field in words (32 bits);
SSRC:
   Synchronization source of the server who grants the access right. The SSRC identifies unambiguously the sender of media streams; it is defined in the RTP packets belonging to the RTCP message;
Name=PoC1:
   Application-defined message name (PoC1=PTT over cellular version 1);
Thread ID 1:
   Identifier of the thread for which the access right is assigned;
Thread ID 2:
   Identifier of the new thread which is generated by the authorized communication contribution.

Table 19 following shows by way of example the format of a TB_Taken_message as RTCP message for notifying that the access right has been assigned with specification of the ID of the new thread which was generated by the authorized communication contribution:

TABLE 19
TB_Taken

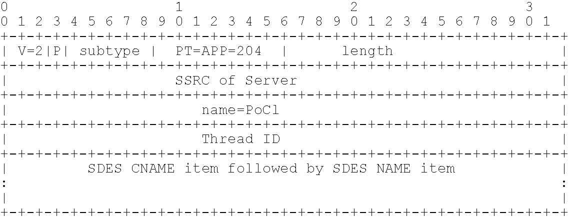

In detail, the fields of the RTCP message shown in Table 19 have the following meaning:
V=2:
   RTP version number;
P:
   Indicator for padding;
subtype:
   Subtype of the message which identifies the message as “TB_Taken” message;
PT=APP=204:
   Indicator for application-defined RTCP message;
Length:
   Length of the message after the length field in words (32 bits);
SSRC:
   Synchronization source of the server who grants the access right. The SSRC identifies unambiguously the sender of media streams; it is defined in the RTP packets belonging to the RTCP message;
Name=PoC1:
Application-defined message name (PoC1=PTT over cellular version 1);
Thread ID:
   Identifier of the new thread which is generated by the authorized communication contribution;
SDES CNAME item followed by SDES NAME item:
   CNAME and NAME of the user terminal to which the access right was assigned;
   CNAME and NAME are so-called SDES items which are defined in SDES RTCP packets in order to describe an RTP party;
   CNAME is an unambiguous name of the party which continues to exist even outside specific RTP sessions (for example composed of user name and host IP address);
   NAME is any name of the party which is typically specified by the party himself.
   NAME does not need to identify the party unambiguously; as in SDES RTCP packets, the list of the SDES items CNAME and NAME is unambiguously concluded by an SDES item of type 00000000; the list is then padded with zeros up to multiples of 32 bits.

The second party T2 who has now been assigned the talk burst 408 sends out his talk contribution (by means of the second PoC client unit 102) which is forwarded to the other parties T1, T3 and T4 by means of the PoC server controlling function 106. After a certain short period of time, the second party T2, or the second PoC client unit 102, respectively, ends its contribution by means of a first TB_Release_message 409 generated by it and transmitted to the PoC server controlling function 106.

Table 20 following shows by way of example the format of a TB_Release_message as RTCP message for ending a communication contribution with specification of the thread identification information which identifies the thread which was generated by the communication contribution ended:

TABLE 20
TB_Release

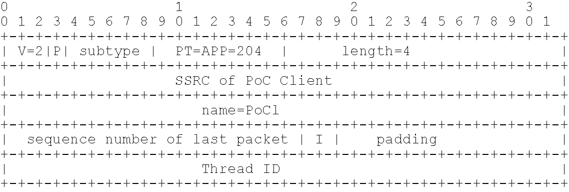

In detail, the fields of the RTCP message shown in Table 20 have the following meaning:
V=2:
   RTP version number;
P:
   Indicator for padding;
Subtype:
   Subtype of the message which identifies the message as “TB_Release” message;
PT=APP=204:
   Indicator for application-defined RTCP message;
Length:
   Length of the message after the length field in words (32 bits);
SSRC:
   Synchronization source of the party terminal that ends its communication contribution; the SSRC identifies unambiguously the sender of media streams; it is defined in the RTCP packets belonging to the RTCP message;
Name=PoC1:
   Application-defined message name (PoC1=PTT over cellular version 1);
Sequence number of last packet:
   Sequence number of the last RTP packet of the communication contribution ended;
I:
   Indicator for ignoring the sequence number field;
Padding:
   Zero data for padding up to the next word boundary;
Thread ID:
   Identifier of the thread which was generated by the communication contribution ended.

Following the reception of the first TB_Release_message 409, the PoC server controlling function 106 informs the other parties T1, T3, T4 that the access right is no longer assigned and thus that the communication contribution which generated the thread with the ID 1 has been ended. For this purpose, the PoC server controlling function 106 generates for each of the parties T1, T3, T4 to be informed in each case a TB_Idle message 410, 411, 412 and sends it out to the respective party T1, T3, T4.

In detail, the PoC server controlling function 106 generates
a first TB_Idle message 410 and transmits it to the first PoC client unit 101 and thus to the first party T1,
a second TB_Idle message 411 and transmits it to the third PoC client unit 103 and thus to the third party T3,
a third TB_Idle message 412 and transmits it to the fourth PoC client unit 108, and thus to the fourth party T4.

Table 21 following shows by way of example the format of a TB_Idle message as RTCP message for notification that the access right is no longer assigned, with specification of the ID of the thread which was generated by the last communication contribution:

TABLE 21
IB_Idle

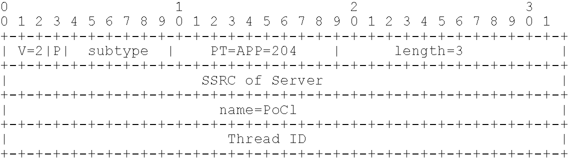

In detail, the fields of the RTCP message shown in Table 21 have the following meaning:
V=2:
   RTP version number;
   P:
   Indicator for padding;
subtype:
   Subtype of the message which identifies the message as “TB_Idle” message;
PT=APP=204:
   Indicator for application-defined RTCP message;
Length:
   Length of the message after the length field in words (32 bits);
SSRC:
   Synchronization source of the server that sends the notification; the SSRC identifies unambiguously the sender of media streams; it is defined in the RTP packets belonging to the RTCP message;
Name=PoC1:
   Application-defined message name (PoC1=PTT over cellular version 1);
Thread ID:
   Identifier of the thread which was generated by the last ended communication contribution.

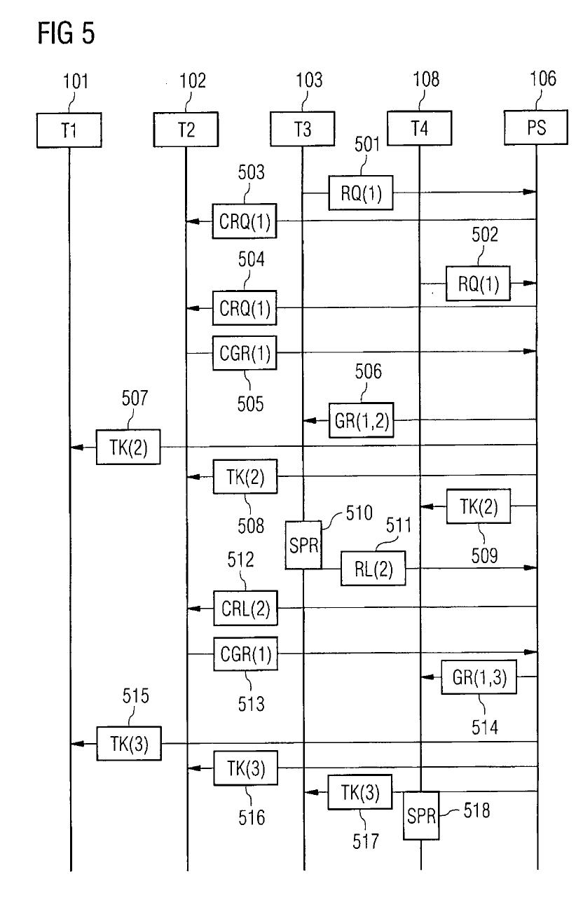

FIG. 5 shows the further course of the conference in another message flow diagram 500.

According to the present exemplary embodiment of the invention, it is also assumed that the third party T3 is requesting, by means of his mobile radio communication terminal, and thus by means of the third PoC client unit 103, and shortly thereafter the fourth party T4 is requesting, by means of his mobile radio communication terminal and thus by means of the fourth PoC client unit 108, the talk burst with respect to the talk contribution by the second party T2.

For this purpose, the third PoC client unit 103 generates a second TB_Request message 501 and transmits it to the PoC server controlling function 106. In the same manner, the fourth PoC client unit 108 generates a third TB_Request message 502 and also transmits it to the PoC server controlling function 106. The two TB_Request messages 501 and 502 in each case contain the thread identification information with the value 1 (ID 1) as reference by means of which the talk contribution of the second party T2 is referred to. The two TB_Request messages 501 and 502 have the same format as the first TB_Request message 401 (compare Table 16).

Following the reception of a respective TB_Request message 501, 502, the PoC server controlling function 106 forwards the request to the second party T2, more precisely to the second PoC client unit 102 since the request (i.e. the thread IDs of the TB_Request messages 501 and 502) refer to the talk contribution of the second party T2.

Forwarding of the requests is implemented by the PoC server controlling function 106, following the reception of the second TB_Request message 501, generating a second Chair_TB_Request message 503 and transmitting it to the second PoC client unit 102. In the same manner, the PoC server controlling function 106, following the reception of the third TB_Request message 502, generates a third Chair_TB_Request message 504 and transmits it to the second PoC client unit 102.

The second party T2, and thus the second PoC client unit 102, grants the talk burst to the third party T3 since the third party T3 has first requested the talk burst. Furthermore, the second party T2, and thus the second PoC client unit 102, stores the request of the fourth party T4 in a queue provided optionally as described above. To implement this, the second party T2 or his second PoC client unit 102, respectively, generates a second Chair_TB_Granted_message 505 and transmits it to the PoC server controlling function 106. In this context, it must be noted that both the two Chair_TB_Request_messages 503, 504 and the second Chair_TB_Granted_message 505 contain the thread identification information with the value 1 (ID 1).

Following the reception of the second Chair_TB_Granted_message 505, the PoC server controlling function 106 generates a second TB_Granted_message 506 and transmits it to the third PoC client unit 103 and thus to the third party T3. The second TB_Granted_message 506 is thus used for granting the access right to the thread with a second thread identification information ID 1 (first digit in brackets in the second TB_Granted_message 506 of FIG. 5), with the message that the thread generated by the communication contribution granted has a third thread identification information ID 2 (second digit in brackets in the second TB_Granted_message 506 of FIG. 5).

In addition, the PoC server controlling function 106 notifies all other parties apart from the third party T3 by means of a respective TB_Taken_message 507, 508, 509 that the talk burst (symbolized by reference symbol 510 in FIG. 5) has been assigned. Furthermore, the TB_Taken_messages 507, 508, 509 are used for informing the parties that the thread assigned as a result has been given the ID which is specified in the thread identification information of the respective TB_Taken_message 507, 508, 509.

In detail, the PoC server controlling function 106 generates
a fourth TB_Taken_message 507 and transmits it to the first PoC client unit 101, and thus to the first party T1,
a fifth TB_Taken_message 508 and transmits it to the second PoC client unit 102, and thus to the second party T2,
a sixth TB_Taken_message 509 and transmits it to the fourth PoC client unit 108, and thus to the fourth party T4.

The third party T3, who has now been allocated the talk burst 510, sends out his talk contribution (by means of the third PoC client unit 103) which is forwarded to the other parties T1, T2 and T4 by means of the PoC server controlling function 106. After a certain period of time, the third party T3 or the third PoC client unit 103, respectively, ends by means of a second TB_Release_message 511 generated by it and transmitted to the PoC server controlling function 106, which contains the specification of the thread identification information with the value 2 of the associated thread. Following the reception of the second TB_Release_message 511, the PoC server controlling function 106 generates a first Chair_TB_Release message 512 with the specification of the thread identification information with the value 2 of the associated thread and sends it to the second PoC client unit 102, and thus to the second party T2.

Once the third party T3 has ended his talk contribution, the second party T2 grants the talk burst to the fourth party T4, for example following the reception of the first Chair_TB₁₃ Release message 512.

To implement this, the second party T2 or his second PoC client unit 102, respectively, generates a third Chair_TB_Granted message 513 and transmits it to the PoC server controlling function 106, wherein the third Chair_TB_Granted message 513 contains the thread identification information with the value 1 (ID 1).

Following reception of the third Chair_TB_Granted_message 513, the PoC server controlling function 106 generates a third TB_Granted_message 514 and transmits it to the fourth PoC client unit 108, and thus to the fourth party T4. The third TB_Granted_message 514 is thus used for granting the access right to the thread with the second thread identification information ID 1 (first digit in brackets in the third TB_Granted_message 514 of FIG. 5), with the message that the thread generated by the communication contribution granted has a fourth thread identification information ID with the value 3 (ID 3) (second digit in brackets in the third TB_Granted_message 514 of FIG. 5).

In addition, the PoC server controlling function 106 notifies all other parties apart from the fourth party T4, by means of a respective TB_Taken_message 515, 516, 517 that the talk burst (symbolized by reference symbol 518 in FIG. 5) has been assigned. Furthermore, the TB_Taken_messages 515, 516, 517 are used for informing the parties that the thread assigned as a result has been given the ID which is specified in the thread identification information of the respective TB_Taken_message 515, 516, 517.

In detail, the PoC server controlling function 106 generates
a seventh TB_Taken₁₃ message 515 and transmits it to the first PoC client unit 101, and thus to the first party T1,
an eighth TB_Taken_message 516 and transmits it to the second PoC client unit 102 and thus to the second party T2,
a ninth TB_Taken_message 517 and transmits it to the third PoC client unit 103, and thus to the third party T3.

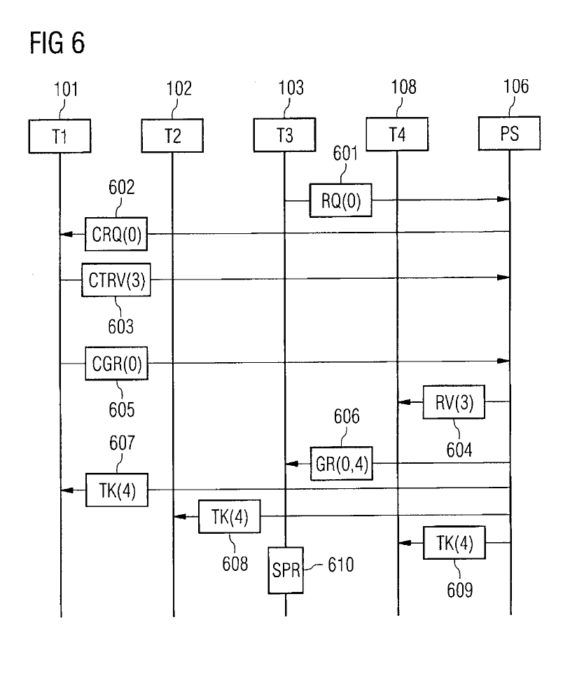

Whilst the fourth party T4 is still speaking, or in other words, whilst the talk burst 518 is still allocated to him, it is assumed, according to the present exemplary embodiment, that the third party T3 is requesting, by means of the third PoC client unit 103, the talk burst to the thread of the communication session by means of a fourth TB_Request message 601 which has the first thread identification information with the value 0 as reference to the communication session and which is transmitted to the PoC server controlling function 106 (compare message flow diagram 600 in FIG. 6).

The PoC server controlling function 106 forwards the request to the first party T1 since the first party T1 is chair of the communication session. This is done by the PoC server controlling function 106 generating a fourth Chair_TB_Request_message 602 and transmitting it to the first PoC client unit 101. To illustrate, the fourth Chair_TB_Request_message 602 is used for requesting the access right from the chair to the thread identified by the thread identification information with the value 0 (ID 0).

It is also assumed that the first party T1 is of the opinion that the talk contribution provided by the second party T2, and thus also the talk contributions related thereto, are of lesser importance and, therefore, withdraws from the second party T2 or, respectively, the second PoC client unit 102 its thread or other words, the access right allocated to it. For this purpose, the first PoC client unit 101 generates a Chair_Thread_Revoke message 603 for terminating the thread identified by the thread identification information with the value 3 (ID 3) and transmits the Chair_Thread_Revoke message 603 to the PoC server controlling function 106.

The PoC server controlling function 106 now terminates the talk contribution of the fourth party T4 currently taking place since the contribution belongs to the thread to be ended. This is done by the PoC server controlling function 106 generating a first TB_Revoke message 604 and transmitting it to the fourth PoC client unit 108. After that, the PoC server controlling function 106 no longer forwards any talk burst requests with reference to the first talk contribution from the second party T2 to the second PoC client unit 102 and thus to the second party T2.

The first party T1, and thus the first PoC client unit 101, grants the talk burst to the third party T3 by the first PoC client unit 101 generating a fourth Chair_TB_Granted_message 605 for granting the access right to the thread with the ID with the value 0 (ID 0) and transmitting it to the PoC server controlling function 106.

Following the reception of the fourth Chair_TB_Granted_message 605, the PoC server controlling function 106 generates a fourth TB_Granted_message 606 and transmits it to the third PoC client unit 103 and thus to the third party T3. The fourth TB_Granted_message 606 is thus used for granting the access right to the thread with a thread identification information ID 0 (first digit in brackets in the fourth TB_Granted_message 606 of FIG. 6), with the message that the thread generated by the authorized communication contribution has a fifth thread identification information ID with the value 4 (second digit in brackets in the fourth TB_Granted_message 606 of FIG. 6). In addition, the PoC server controlling function 106 notifies all other parties apart from the third party T3, by means of a respective TB_Taken_message 606, 608, 609 that the talk burst (symbolized by reference symbol 610 in FIG. 6) has been assigned. Furthermore, the TB_Taken_messages 607, 608, 609 are used for informing the parties that the thread assigned by this means has received the ID which is specified in the thread identification information of the respective TB_Taken message 607, 608, 609.

In detail, the PoC server controlling function 106 generates
a tenth TB_Taken_message 607 and transmits it to the first PoC client unit 101, and thus to the first party T1,
an eleventh TB_Taken_message 608 and transmits it to the second PoC client unit 102, and thus to the second party T2,
a twelfth TB_Taken_message 609 and transmits it to the fourth PoC client unit 108, and thus to the fourth party T4.

Table 22 following shows by way of example the format of a Chair_Thread_Revoke message as RTCP message for terminating a thread by the chair of the higher-level thread:

TABLE 22
Chair_Thread_Revoke

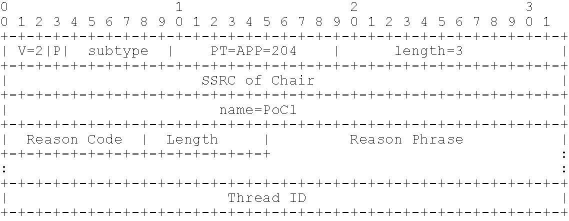

In detail, the fields of the RTCP message shown in Table 22 have the following meaning:
V=2:
   RTP version number;
P:
   Indicator for padding;
subtype:
   Subtype of the message which identifies the message as “Chair_Thread_Revoke” message;
PT=APP=204:
   Indicator for application-defined RTCP message;
Length:
   Length of the message after the length field in words (32 bits);
SSRC:
   Synchronization source of the party terminal of the chair who ends the thread; the SSRC identifies unambiguously the sender of media streams; it is defined in the RTP packets belonging to the RTP message;
Name=PoC1:
   Application-defined message name (PoC1=PTT over cellular version 1);
Reason Code:
   Code for identifying a reason for termination;
Length:
   Length of the “reason phrase” field in bytes;
Reason Phrase:
   Explanation of the termination as text;
Thread ID:
   Identifier of the thread which is to be terminated.

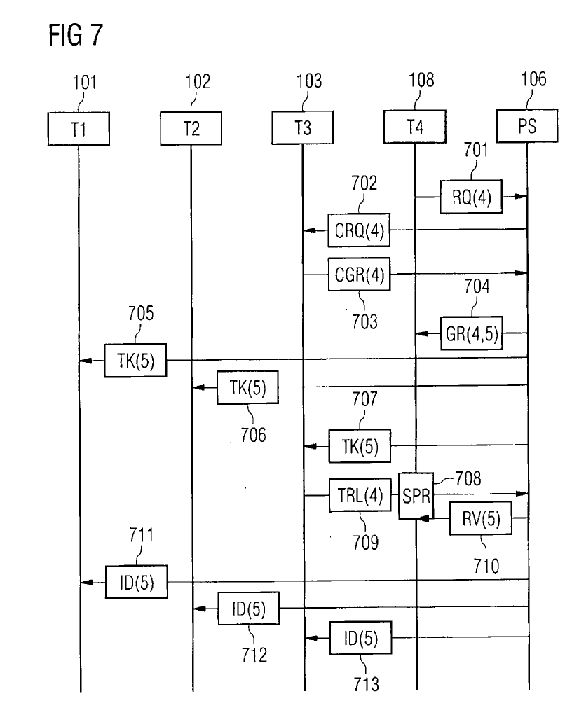

The third party T3 now hands over his talk contribution whereupon the fourth party T4 requests the talk burst with reference to the third party T3 and receives it from the third party T3. This is done by the fourth PoC client unit 108 generating a fifth TB_Request message 701 for requesting the access right to the thread with the ID 4 from the PoC server controlling function 106 and transmitting it to the PoC server controlling function 106 (see message flow diagram 700 in FIG. 7).

Furthermore, the PoC server controlling function 106, following the reception of the fifth TB_Request message 701, generates a fifth Chair_TB_Request_message 702 for requesting the access right to the thread with the ID 4 from the chair and transmits it to the third PoC client unit 103 which acts as chair for this thread since it has generated this thread. The third PoC client unit 103 authorizes the requested access right by means of a fifth Chair_TB_Granted_message 703, generated by it and transmitted to the PoC server controlling function 106, for granting the access right to the thread with the ID 4 by the chair.

Following the reception of the fifth Chair_TB_Granted_message 703, the PoC server controlling function 106 generates a fifth TB₁₃ Granted_message 704 and transmits it to the fourth PoC client unit 108, and thus to the fourth party T4. The fifth TB_Granted_message 704 is thus used for authorizing the access right to the thread with the fifth thread identification information ID 4 (first digit in brackets in the fifth TB_Granted_message 704 of FIG. 7), with the message that the thread generated by the authorized communication contribution has a sixth thread identification information ID with the value 5 (ID 5) (second digit in brackets in the fifth TB_Granted_message 704 of FIG. 7).

In addition, the PoC server controlling function 106 notifies all other parties apart from the fourth party T4 by means of a respective TB_Taken_message 705, 706, 707 that the talk burst (symbolized by reference symbol 708 in FIG. 7) has been assigned. Furthermore, the TB_Taken_messages 705, 706, 707 are used for informing the parties that the thread assigned by this means has received the ID which is specified in the thread identification information of the respective TB_Taken_message 705, 706, 707.

In detail, the PoC server controlling function 106 generates
a thirteenth TB_Taken_message 705 and transmits it to the first PoC client unit 101, and thus to the first party T1,
a fourteenth TB_Taken_message 706 and transmits it to the second PoC client unit 102, and thus to the second party T2,
a fifteenth TB_Taken_message 707 and transmits it to the third PoC client unit 103, and thus to the third party T3.

After a while, the third party T3 is of the opinion that the fourth party T4 has said everything that is important with respect to the communication contribution and, therefore, ends the thread. For this purpose, the third party T3 generates a Thread_Release message 709 for ending the thread with the ID 4 by the chair of the thread and transmits it to the PoC server controlling function 106.

Table 23 following shows by way of example the format of a Thread_Release message as RTCP message for ending a thread by the chair of the thread:

TABLE 23
Thread_Release

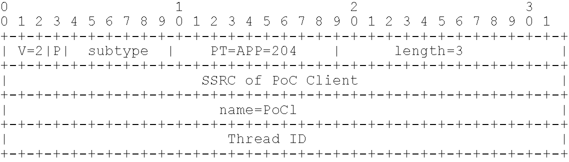

In detail, the fields of the RTCP message shown in Table 23 have the following meaning:
V=2:
   RTP version number;
P:
   Indicator for padding;
subtype:
   Subtype of the message which identifies the message as “Thread_Release” message;
PT=APP=204:
   Indicator for application-defined RTCP message;
Length:
   Length of the message after the length field in words (32 bits);
SSRC:
   Synchronization source of the party terminal that ends its thread; the SSRC identifies unambiguously the sender of media streams; it is defined in the RTP packets belonging to the RTCP message;
Name=PoC1:
   Application-defined message name (PoC1=PTT over cellular version 1);
Thread ID:
   Identifier of the thread which is to be ended.

Following the reception of the Thread_Release message 709, the PoC server controlling function 106 withdraws the talk burst from the fourth party T4 by means of a second TB_Revoke message 710, generated by the PoC server controlling function 106 and transmitted to the fourth PoC client unit 108, for withdrawing the access right for the contribution which has generated the thread with the ID 5.

Furthermore, the PoC server controlling function 106 informs the other parties T1, T2, T3 that the access right is no longer assigned and thus that the communication contribution which has generated the thread with the ID 5 has been terminated. For this purpose, the PoC server controlling function 106 generates in each case a TB_Idle message 711, 712, 713 for each party T1, T2, T3 to be informed and sends it to the respective party T1, T2, T3.

In detail, the PoC server controlling function 106 generates
a fourth TB_Idle message 711 and transmits it to the first PoC client unit 101, and thus to the first party T1,
a fifth TB_Idle message 712 and transmits it to the second PoC client unit 102, and thus to the second party T2,
a sixth TB_Idle message 713 and transmits it to the third PoC client unit 103, and thus to the third party T3.

In the text which follows, some alternative embodiments to the above exemplary embodiments will be shown.

For the thread of the communication session, another default identification information (default ID) than the value “0” can also be used.

The access right can also be requested with respect to an own contribution. This means that a party can request the access right to a thread which is chaired by him himself.

The access right can also be controlled by machine, that is to say automatically. In this case, the chair is not a person but a device set up correspondingly. The device assigns the access right automatically, for example by using a queue, described above, and/or with a predeterminable maximum communication time.

Furthermore, it can be provided that it is also allowed to request a number of access rights to various threads by one party. The party is then a multiple chair (for the threads of his contributions). If it is not allowed to request a number of access rights, the thread ID in the grant messages is superfluous and formats without an ID can be used for these messages.

It can also be provided that the chair of a thread automatically receives the access right for his own thread when no other party has the access right for the thread. The automatic assignment of an access right can be implemented, for example, in the PTT server or in the terminal of the chair. If the assignment is implemented in the PTT server, the server automatically assigns the access right with a TB_Granted message to the chair. If the assignment is implemented in the terminal of the chair, the terminal application automatically assigns the access right to the chair by sending out a corresponding Chair_TB_Granted message to the PTT server. The PTT server forwards the message as TB_Granted message to the chair as communication party as in the above example.

The thread identification information can also be used with communication control messages which do not contain any thread identification information. These messages then always relate to the thread of the PTT session. As a result, the embodiments of the invention become compatible with the previous communication control messages defined for PTT systems. In addition, the use of communication control messages without thread identification information saves transmission bandwidth.

It can also be provided to send out the identification information of a new thread with the communication contribution which initiates the thread. It is then no longer required to inform all parties receiving the communication contribution about the identification information of the new thread with a TB_Taken message.

The access right control messages can also be sent out with other protocols than with RTCP, for example with the Binary Floor Control Protocol (BFCP) or with extensions or developments thereof.

Embodiments of the invention can be used not only in a PTT system for transmitting audio data but also in systems for transmitting other data, particularly media data such as, for example, video data, still image data, text data etc.

Embodiments of the invention can be used not only in a PTT system but also in other systems with access right control, especially generally in any conference communication system.

1-41. (canceled)

42. A method for the computer-aided assignment of an access right in a communication conference between a plurality of communication terminals to at least one communication terminal, wherein the communication conference has at least one unambiguously identifiable conference media data flow, comprising:
assigning the access right within the communication conference by taking into consideration the conference media data flow.

43. The method as claimed in claim 42, wherein the at least one conference media data flow has at least one contribution which refers to the communication conference or to another contribution in the communication conference.

44. The method as claimed in claim 42, wherein the communication conference has a plurality of unambiguously identifiable conference media data flows, further comprising assigning the access right within the communication conference by taking into consideration at least one conference media data flow of the plurality of conference media data flows.

45. The method as claimed in claim 42, further comprising assigning the access right by taking into consideration an access right request message.

46. The method as claimed in claim 45, further comprising receiving at least one access right request message.

47. The method as claimed in claim 46, wherein the at least one access right request message contains identification information for identifying the conference media data flow within which an access right is requested.

48. The method as claimed in claim 42, wherein a communication session based communication conference is used as the communication conference.

49. The method as claimed in claim 42, wherein an Internet based communication conference is used as the communication conference.

50. The method as claimed in claim 42, wherein a push to talk communication conference is used as the communication conference.

51. The method as claimed in claim 50, wherein a push to talk over cellular communication conference is used as the communication conference.

52. The method as claimed in claim 45, further comprising coding the access right request message in accordance with an access right assignment protocol.

53. The method as claimed in claim 52, further comprising coding the access right request message in accordance with the Binary Floor Control Protocol.

54. The method as claimed in claim 45, further comprising coding the access right request message in accordance with a control protocol for controlling a media data transmission protocol.

55. The method as claimed in claim 54, further comprising coding the access right request message in accordance with a real time control protocol for controlling a real time media data transmission protocol.

56. The method as claimed in claim 55, further comprising coding the access right request message in accordance with the Real Time Transport Control Protocol.

57. The method as claimed in claim 42, further comprising assigning the access right within the communication conference by a chair of the conference media data flow.

58. The method as claimed in claim 57, further comprising assigning the access right within the communication conference by the initiator of the conference media data flow.

59. The method as claimed in claim 58, further comprising assigning the access right within the communication conference by a party who has made a contribution to which contributions of the conference media data flow are related.

60. The method as claimed in claim 59, further comprising ending the conference media data flow by the initiator of the conference media data flow.

61. A method for the computer-aided generation of a communication conference message in a communication conference between a plurality of communication terminals, comprising adding to the communication conference message an identification information of a conference media data flow within the communication conference for the unambiguous identification of the conference media data flow or of a communication contribution in the conference media data flow.

62. The method as claimed in claim 61, wherein the communication conference message is an access right request message for requesting an access right.

63. The method as claimed in claim 61, wherein the communication conference message is a message flow access right authorization message, wherein the message flow access right authorization message specifies that the access right has been authorized in the message flow.

64. The method as claimed in claim 61, wherein the communication conference message is a message flow terminating message for terminating the conference media data flow.

65. The method as claimed in claim 64, further comprising generating the message flow terminating message by a chair of the conference media data flow.

66. The method as claimed in claim 61, wherein the communication conference message is a message flow access right withdrawal message for withdrawing the access right in the message flow.

67. The method as claimed in claim 66, further comprising generating the message flow access right withdrawal message by a chair of the conference media data flow.

68. The method as claimed in claim 61, wherein the communication conference message is an access right assigned message, wherein the access right assigned message specifies that the access right has been assigned.

69. The method as claimed in claim 61, wherein the at least one conference media data flow comprises at least one contribution which relates to the communication conference or to another contribution in the communication conference.

70. The method as claimed in claim 61, wherein the at least one conference media data flow comprises at least one contribution which relates to the communication conference or to another contribution in the communication conference, and wherein the communication conference message is a communication contribution released message, which specifies that the access right with regard to the communication contribution is not assigned.

71. The method as claimed in claim 61, wherein the at least one conference media data flow comprises at least one contribution which relates to the communication conference or to another contribution in the communication conference, and wherein the communication conference message is a communication contribution terminating message for terminating the communication contribution.

72. The method as claimed in claim 61, wherein the communication conference message is an access right assigned message, which specifies that the access right has been assigned, and wherein the communication conference message is a communication contribution access right withdrawal message for withdrawing the access right in the communication contribution.

73. The method as claimed in claim 61, further comprising coding the communication conference message in accordance with an access right assignment protocol.

74. The method as claimed in claim 73, further comprising coding the communication conference message in accordance with the Binary Floor Control Protocol.

75. The method as claimed in claim 61, further comprising coding the communication conference message in accordance with a control protocol for controlling a media data transmission protocol.

76. The method as claimed in claim 75, further comprising coding the communication conference message in accordance with a real time control protocol for controlling a real time media data transmission protocol.

77. The method as claimed in claim 76, further comprising coding the communication conference message in accordance with the Real Time Transport Control Protocol.

78. An access right assignment unit for assigning an access right in a communication conference between a plurality of communication terminals to at least one communication terminal,
wherein the communication conference comprises at least one unambiguously identifiable conference media data flow, and
wherein the access right assignment unit assigns the access right within the communication conference by taking into consideration the conference media data flow.

79. A communication conference server unit with an access right assignment unit as claimed in claim 78.

80. A communication conference message generating unit for the computer-aided generation of a communication conference message in a communication conference between a plurality of communication terminals, wherein an identification information of a conference media data flow within the communication conference can be added to the communication conference message for unambiguously identifying the conference media data flow.

81. A communication terminal with a communication conference message generating unit as claimed in claim 80.

82. A method for the computer-aided initialization of a conference media data flow in a communication conference between a plurality of communication terminals, comprising:
generating a conference media data flow in the communication conference; and
allocating an unambiguous identification information to the conference media data flow for the unambiguous identification of the message flow within the communication conference.
